(19) United States
(12) Patent Application Publication
(10) Pub. No.: US 2003/0144865 A1
(43) Pub. Date: Jul. 31, 2003

(54) E-commerce back-end hierarchical data management system and method

(76) Inventors: Kuang Shin Lin, Taipei (TW); Feng Hua Li, Tianjin (CN)

Correspondence Address: JACOBSON HOLMAN PLLC, 400 SEVENTH STREET N.W., SUITE 600, WASHINGTON, DC, 20004, US

(21) Appl. No.: 10/198,089

(22) Filed: Jul. 19, 2002

(30) Foreign Application Priority Data
Jul. 24, 2001 (TW) 90117987

(51) Int. Cl. G06F 17/60

(52) U.S. Cl. 705/1; 709/203; 707/10

(57) ABSTRACT

An e-commerce back end hierarchical data management system and method is applied on an e-commerce Net. It further comprises a registering unit, modifying unit, and identifying unit. The registering unit provides client registration and a working mechanism based on different client hierarchies. The modifying unit provides clients with steps for data modification to edit data and information. The identifying unit identifies and confirms those who log onto respective working platforms, and then opens appropriate working platforms for individual client operations according to their confirmed identity levels.

### BACKGROUND OF THE INVENTION

1. Field of the Invention

The invention relates to a hierarchical data management system and method, and particularly a system and method being setup on an e-commerce server to manage its back end data manage.

2. Related Art

The Internet is a worldwide network system; through it users can access data on other systems, or even directly talk to other users of various systems. The Internet is the aggregation of huge amounts of networks using Transmission Control Protocol/Internet Protocol (TCP/IP) as the standard of data transmission. It crosses geographical boundaries to connect various networks, including industries, universities, government institutions, and research organizations.

With the development of Internet technology, the traditional retail industry faces unprecedented challenges, as it has been thoroughly revolutionized by e-commerce capabilities. The e-commerce mode enables users to obtain and analyze consumer information through an Internet browser and to have instant and advanced communication with one another on the Net. As for e-commerce Web sites, the point of information processing at the back end is indispensable to give assurance of data security, so unauthorized users are not allowed to access and modify data. The presently known technology of managing messages and information at the back end of e-commerce Web sites involves dividing the back end into independent message/information process units according to different messages/information for different clients to process. Such an operation may ensure a certain level of security in message/information operations at the back end, however, the data is not integrated. From the data security standpoint (The other hand of data security standpoint), it is hard to assure overall data security with this kind of technology because data and information processing is done separately, and there are substantial client identification problems.

Hence, how to perform data and information processing on the whole from the back end and assure data security at the same time have become problems on e-commerce Web sites to be resolved.

### SUMMARY OF THE INVENTION

In view of the foregoing, the invention aims at resolving the preceding disadvantages to provide a hierarchical data management system and method at the back end of e-commerce Web sites. The primary object of the invention is to manage e-commerce back-end data manage to assure data security of the back end on the Net.

The disclosed system includes the registering unit, the modifying unit, and the identifying unit. The registering unit provides client registration and a working mechanism based on different client hierarchies. The modifying unit provides clients with steps for data modification to edit data and information. The identifying unit identifies and confirms those who log onto respective working platforms, and then opens appropriate working platforms for individual client operations, according to confirmed identity levels.

The disclosed invention at least consists of: setting up at least one working unit through a back end hierarchical data management system of e-commerce; processing corresponding data and information based on attributes of the working unit; and logistically managing data manage through the back end hierarchical data management system of e-commerce.

The foregoing, as well as additional objects, features and advantages of the invention will be more readily apparent from the following detailed description, which proceeds with reference to the accompanying drawings. Specific structures and functional details disclosed hereunder are not to be interpreted as limiting, but merely as a basis for the claims and as a representative basis for teaching one skilled in the art to variously employ the invention.

### BRIEF DESCRIPTION OF THE DRAWINGS

FIG. 1 is a schematic representation of the e-commerce back end hierarchical data management system and method of the invention.

FIG. 2 is a block diagram of the e-commerce back end hierarchical data management system and method of the invention.

FIG. 3 is a flowchart representation of the registering unit of the invention.

FIG. 4 is a flowchart representation of the modifying unit of the invention.

FIG. 5 is a flowchart representation of the identifying unit of the invention.

FIG. 6 is a perspective view of an embodiment of the invention.

### DETAILED DESCRIPTION OF THE INVENTION

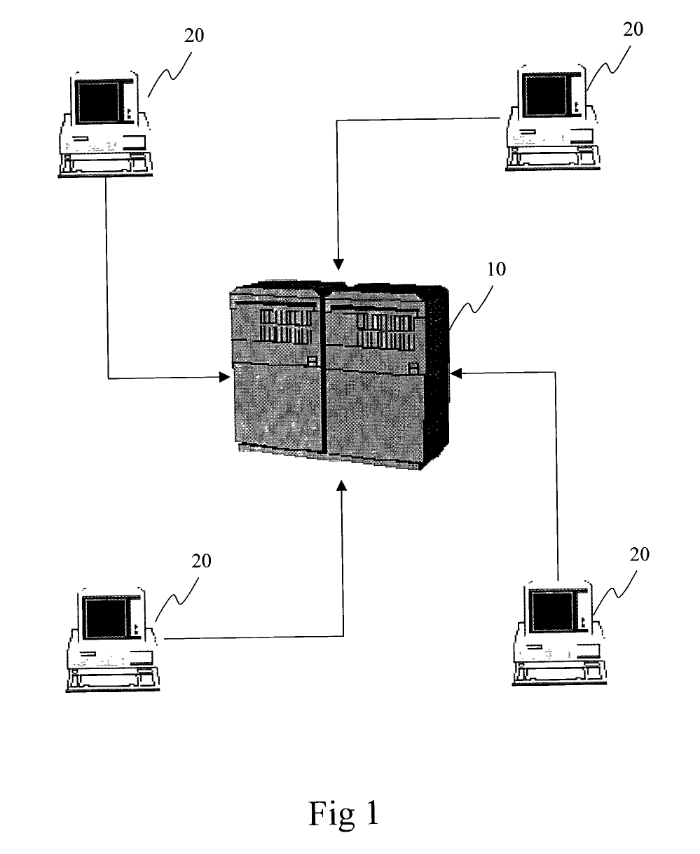

The invention proposes a system and method of hierarchical data management at the back end of e-commerce Web sites. In particular, it is applied to establish an e-commerce server 10 on the e-commerce Web to serve one client 20. The aforementioned is as shown in FIG. 1, which is a schematic representation of the e-commerce back end hierarchical data management system and method of the invention.

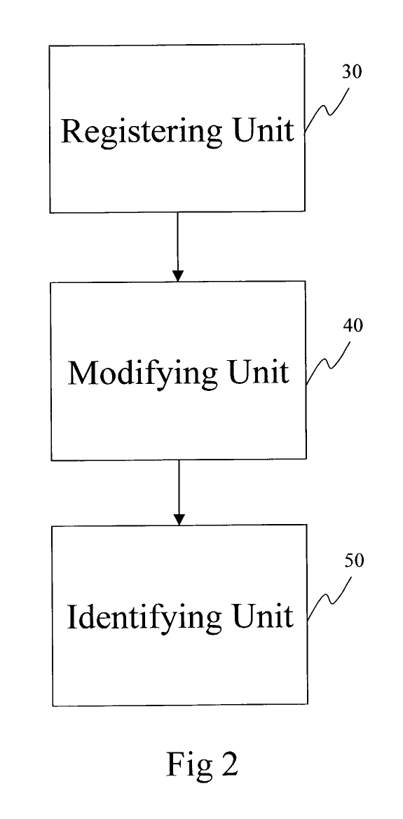

As shown in FIG. 2, which is a block diagram of the e-commerce back end hierarchical data management system and method, the invention comprises at least: the registering unit 30, the modifying unit 40, and the identifying unit 50. The registering unit 30 is to establish data of clients on the management system with identification mechanisms, which includes the account identification mechanism and the password identification mechanism to identify clients when they log on for registration. Once an identity is verified, the registering unit 30 sets a working mechanism, which can be a session mechanism to classify the client into the appropriate hierarchy and transfer data of the client. The modifying unit 40 edits data of clients and stores updated data of clients onto a storage media, which is set on the e-commerce server 10. The identifying unit 50, connecting with working platforms, identifies clients and opens corresponding working platforms for clients to operate the system, according to classified client levels.

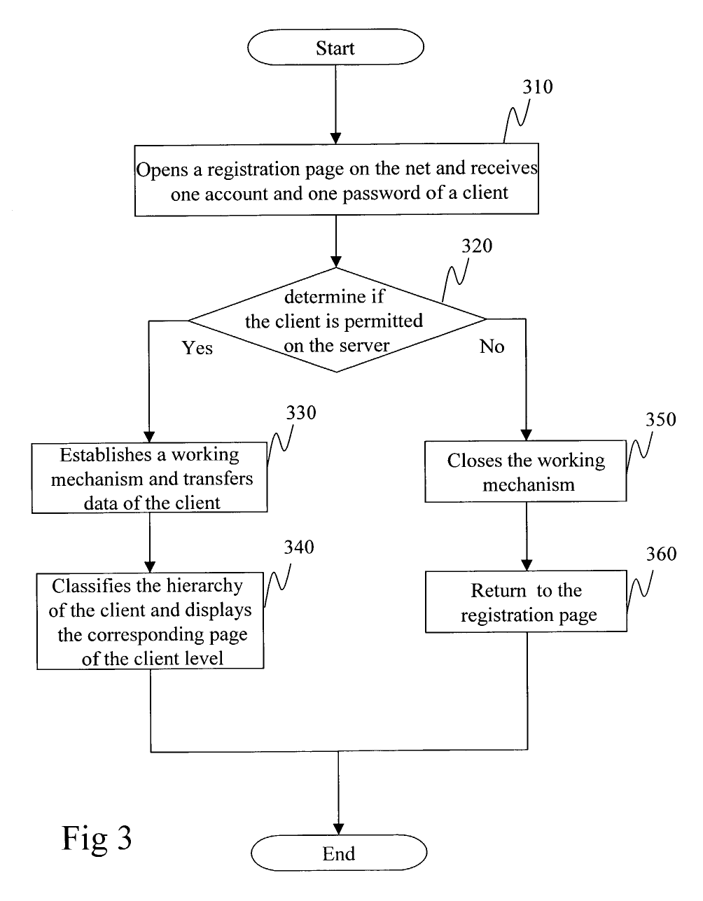

In addition to the above-mentioned representation and diagram, the invention further comprises the method and steps for managing back end data manage as shown in FIG. 3, a flowchart representation of the registering unit of the invention.

The e-commerce network server 10 first predetermines accounts and passwords for all clients, opens a registration page on the Net and is ready to receive one account and one password when a client logs onto the registration page (step 310). The registering unit identifies the account and password of the client and determines whether the client is permitted on the server (step 320). Once confirmed, the registering unit further establishes a working mechanism and transfers data of the client (step 330), classifies the hierarchy of the client and displays the corresponding page of the client level (step 340). If the identification is incorrect, the registering unit then closes the working mechanism (step 350), returns to the registration page and waits for a new account and a password (step 360).

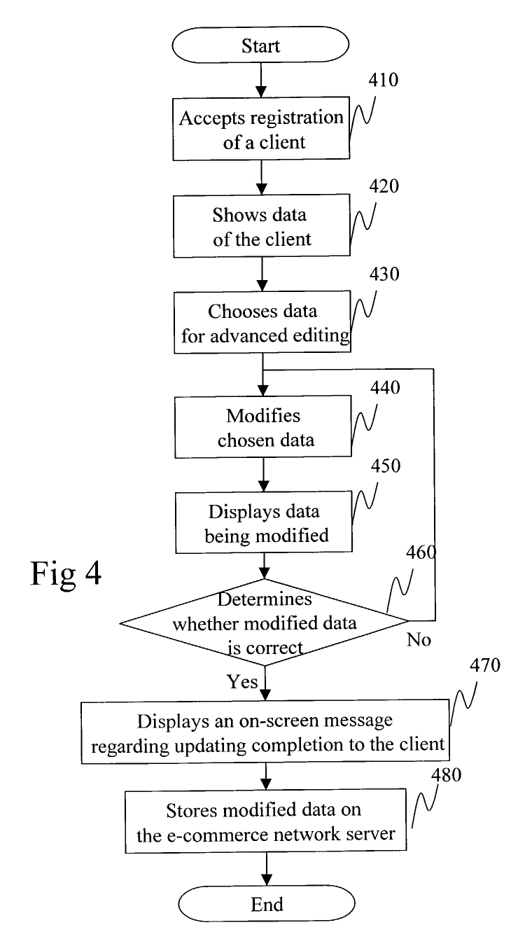

FIG. 4 illustrates a flowchart representation of the modifying unit of the invention. Details are provided hereunder.

The e-commerce network server 10 first accepts registration of a client (step 410) and shows data of the client following this log-on action (step 420). The client is able to choose data for advanced editing (step 430) and modify that data (step 440). The modifying unit then displays data being modified (step 450) and determines whether the modified data is correct (step 460). If yes, the modifying unit displays an on-screen message regarding updating completion to the client (step 470) and stores modified data on the e-commerce network server 10 (step 480). Otherwise, the flow goes to step 440 to allow the client to continuously modify chosen data.

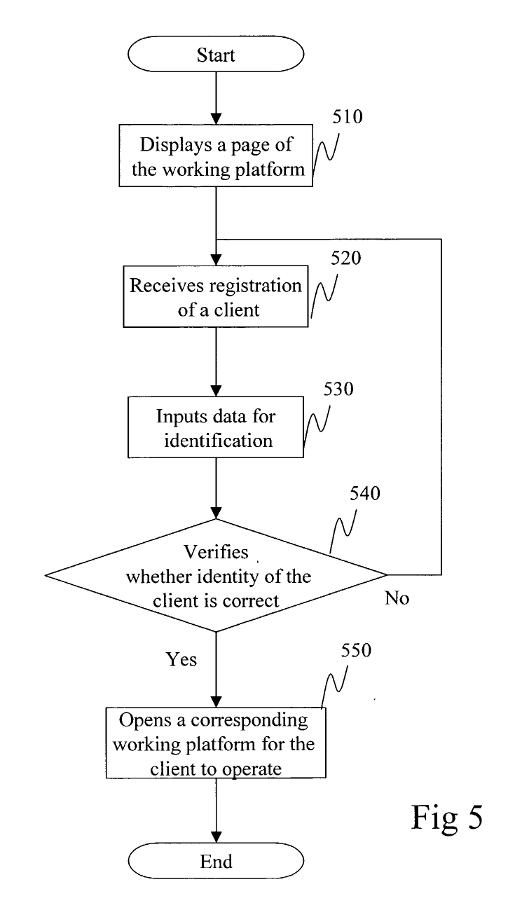

FIG. 5 is a flowchart representation of the identifying unit of the invention. Details are provided hereunder.

The e-commerce network server 10 first provides a working platform and displays a page of the working platform (step 510) to enable a client to log on for registration through the e-commerce network server 10 (step 520) and to ask the client to input data for identification (step 530). The identifying unit 50 then verifies the identity of the client (step 540). After the client is verified, the identifying unit creates a corresponding working platform for the client to operate (step 550). If the client cannot be identified, the flow goes to the page of the working platform where the client is asked to re-log on for registration.

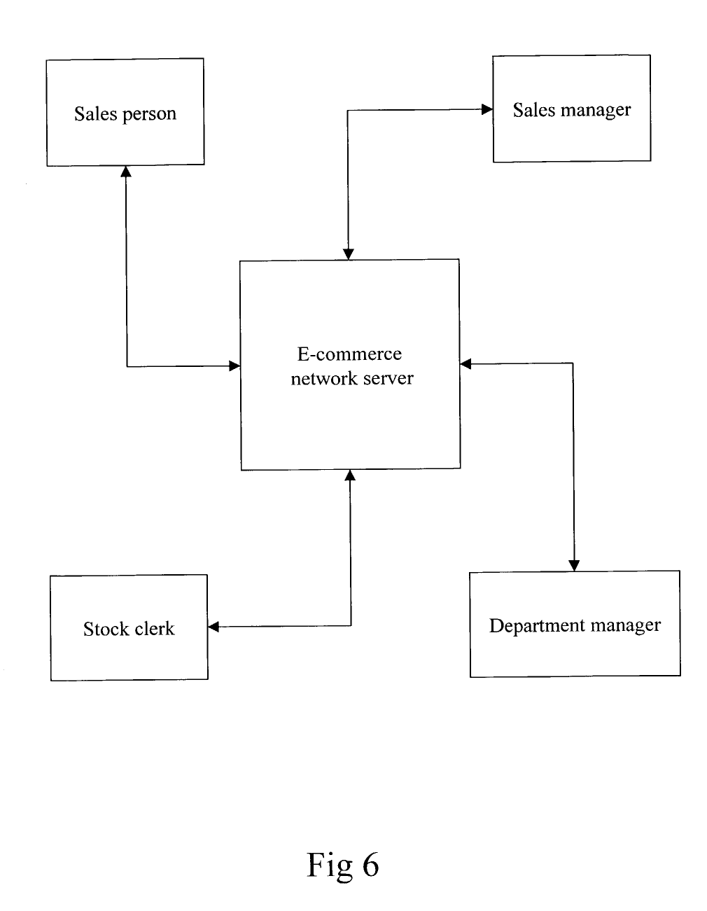

According to the aforementioned, the feasibility and practicality of the invention will be further elaborated by means of an embodiment depicted in the following. FIG. 6 is a perspective view of an embodiment of the invention. Details are provided hereunder.

The disclosed e-commerce back end hierarchical data management system and its method comprises four kinds of client levels, which are a sales person, a sales manager, one department manager, and a stock clerk. A sales person can utilize the disclosed system to complete the following tasks: confirming franchiser information/messages, verifying orders from franchisers, registering a bill of payment, and ensuring payment is remitted, etc. In addition to the above external tasks there are some internal processes, which can also utilize the disclosed invention, such as checking goods delivering registrations, searching information/messages of purchasing orders and distribution of goods on respective franchisees territories. A sales manager can utilize the disclosed system to complete the following tasks: making the initial confirmation of forms for delivering goods, checking information and statistics of order intakes, searching purchase order information of all franchisers, and goods delivering information.

A department manager can utilize the disclosed system to complete the following tasks: making the second confirmation of forms for delivering goods, checking information and statistics of order intakes, checking purchase order information of all franchisers, and goods delivering information. A stock clerk can utilize the disclosed system to complete the following tasks: making the third confirmation of forms for delivering goods, and delivering delivering information. A stock clerk can utilize the disclosed system to complete the following tasks: making the third confirmation of forms for delivering goods, and delivering goods after confirmation.

First, a client logs onto the back end of the Net for operation. When the client registers on the Net the e-commerce network server determines whether the client is permitted to operate the system. If yes, the e-commerce server 10 further classifies the client into an appropriate hierarchy of operation: a sales person, a sales manager, a department manager, or a stock clerk. According to the above organization structure, pages of various working platforms are opened for respective working processes. For example, a sales person can utilize sales processing pages, which are divided based on selling territories, to process the operations of identifying franchisers, handling purchase orders, confirming bills of payment, and completing forms for delivering goods. The sales manager, department manager, and stock clerk can respectively process information operations such as confirming forms for delivering goods, and distributing goods from a stock house/inventory center.

According to the aforementioned, the disclosed e-commerce back end hierarchical data management system and method utilizes information processing platforms on the Web to open corresponding information/messages based on different client hierarchies, and achieve heightened security for managing the back end data hierarchies on e-commerce Web sites. As the disclosed invention utilizes a method of Web page management, it enables clients to manage their operations wherever they are without geographical boundaries, which greatly heightens working efficiency.

The invention in the form of a system and method for managing e-commerce back-end hierarchical data is disclosed herein. These and other variations, which will be appreciated by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

What is claimed is:

1. An e-commerce back end hierarchical data management system and its method is applied on an e-commerce Net. The disclosed invention includes at least the following units:
one registering unit is to establish data of clients on the management system with an identification mechanism to identify clients while they log on for registration. Once an identity is verified, the registering unit sets a working mechanism to classify the client into appropriate hierarchy and transfer data of the client;
one modifying unit is to edit data of the client and store updated data of the client onto a storage media; and
one identifying unit, connecting at least one working platform, is to identify the client and open a corresponding working platform for the client to operate the system, according to the classified client level.

2. The invention as recited in claim 1, wherein a working platform is an information process platform on the Web.

3. The invention as recited in claim 1, wherein a working mechanism is a session mechanism.

4. The invention as recited in claim 1, wherein a storage media is set on an e-commerce network server.

5. The invention as recited in claim 1, wherein an identification mechanism further includes an account identification mechanism and a password identification mechanism.

6. An e-commerce back end hierarchical data management method is applied on an e-commerce Net, it consists at least of the following steps
setting up at least one working unit through an e-commerce back end hierarchical data management system;
processing corresponding data and information based on attribute of the working unit; and
logistically managing data manage through the e-commerce back end hierarchical data management system.

7. The invention as recited in claim 6, wherein one working unit further comprises the following units: one registering unit, one modifying unit, and one identifying unit.

8. The invention as recited in claim 7, wherein one registering unit further comprises steps of the following.
predetermining accounts and passwords for all clients, opens a registration page on the Net through the e-commerce network server;
receiving one account and one password, when a client logs on the registration page;
identifying an account and a password of the client;
establishing a working mechanism, once verifying the identity, and transfers data of the client; and
classifying the hierarchy of the client and displays corresponding page based on the client level.

9. The invention as recited in claim 8, wherein the step of identifying an account and a password of the client further comprise the following steps.
closing the working mechanism, if the identification is incorrect;
returning to the registration page and waiting for a new account and a new password.

10. The invention as recited in claim 7, wherein one modifying unit further comprises the steps of the following:
asking for logging on registration by a client through the e-commerce network server;
displaying data of the client through the e-commerce network server for the client to choose;
displaying modified data, after being completed, for the client to check if modified data is correct;
storing modified data of the client on the e-commerce network server.

11. The invention as recited in claim 7, wherein one identifying unit further comprises the steps of the following:
providing at least one working platform though the e-commerce network server and displaying a page of the working platform;
logging on for registration by a client through the e-commerce network server;
verifying identity of the client by the identifying unit; and
opening a corresponding working platform for the client to operate, after the client is verified.

12. The invention as recited in claim 11, wherein the step of verifying identity of the client by the identifying unit further comprises the steps of the following:
returning to the page of the working platform, if the identification in incorrect; and
re-verifying the client by the identifying unit.
